(19) United States
(12) Patent Application Publication
(10) Pub. No.: US 2026/0276605 A1
(43) Pub. Date: Sep. 17, 2026

(54) MODULAR LIQUID CHROMATOGRAPHY PUMP SYSTEM

(71) Applicant: MICROMICS TECHNOLOGIES LLC, Spanish Fork, UT (US)

(72) Inventors: Xiaofeng XIE, Provo, UT (US); Thy TRUONG, Provo, UT (US)

(73) Assignee: MICROMICS TECHNOLOGIES LLC, Spanish Fork, UT (US)

(21) Appl. No.: 19/078,071

(22) Filed: Mar. 12, 2025

(51) Int. Cl. G01N 30/32; G01N 30/88

(52) U.S. Cl. CPC G01N 30/32; G01N 30/88; G01N 2030/324; G01N 2030/326; G01N 2030/328; G01N 2030/8881

(57) ABSTRACT

A modular liquid chromatography pump system. The system includes a base member and/or one or more fully independent and self-contained pump units configured to removably attach to the base member for performing chromatography. Ready interchangeability of independent pump units allows the system to continue operation in the event one pump unit is inoperable. Also, the system is highly versatile to perform various types of chromatographic systems because varying numbers of pump units can be employed in different configurations. Pump unit components may include one or more of a pump, valve, pressure sensor, and/or flow sensor, which may be in communication with each other, including in a series. Pump units may be operated via various modes to perform liquid chromatography.

### GOVERNMENT SUPPORT CLAUSE

This invention was made with government support under 75N91023C00027 awarded by the National Institutes of Health. The government has certain rights in this invention.

### BACKGROUND OF THE INVENTION

High-performance liquid chromatography (HPLC), formerly referred to as high-pressure liquid chromatography, is a technique in analytical chemistry used to separate, identify, and quantify specific components in mixtures. There are various detectors used for HPLC. For example, a mass spectrometer/mass spectrometry (MS) is commonly used to measure the components from the liquid chromatography system. This system is referred to as liquid chromatography-mass spectrometry (LC-MS). LC-MS relies on high pressure pumps that deliver mixtures of various solvents (i.e. mobile phase) that flow through the system, collect the sample mixture on the way, deliver it into a cylinder (i.e. column) filled with solid particles, made of adsorbent material (i.e. the stationary phase). An example of one of Applicant's particular applications of LC-MS, and methods relevant thereto, may be found in U.S. Pat. Pub. No. 20230266281.

Various types of high pressure pump systems to accomplish HPLC, LC, and/or LC-MS are known. Main components for such systems may include a pumping sub-system, detector sub-system, and sample introduction sub-system. Current pump systems are configured to achieve a fixed workflow, with one, two, three, four, or five pumps. It is typically not possible to upgrade an existing system from one or two pumps to more pumps to accommodate alternative workflows. Notably, in such systems, the pumps are effectively integrated with the system such that, if there is breakdown in the system, all pumps must go offline as the entire system is serviced and/or repaired. Accordingly, the design of current systems introduces inherent vulnerability into LC work efficiency. What is needed is a system having modular and independent pumping systems where, if one or more pumps breakdown, these may be serviced and/or repaired, while remaining (or replacement) pumps in the system continue to work.

### SUMMARY OF THE INVENTION

In accordance with the above, a new modular liquid chromatography pump system is provided. Embodiments of the system include a base member and independent pump units configured to removably attach to and generally within the base member. Pump units are configured to pump fluid independently in and out of the pump unit for liquid chromatography. Pump units may include one or more of a pump, valve, pressure sensor, and/or flow sensor, which may be in communication, including in a series. Each pump unit may also be configured to operate in one or more modes, including a: (1) fill mode whereby the pump is fillable and/or filled with fluid; (2) an optional block mode whereby the flow path is closed and fluid does not move through the pump unit; and (3) a flow mod whereby the flow path is open and fluid may move through the pump unit. Different number(s) of pumps can be added or reduced to accommodate different workflows and pump units can be rapidly exchanged to minimize downtime for service. Accordingly, the vulnerability problem of integrated pump systems within HPLC, LC, and/or LC-MS platforms is solved.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a front perspective view of a modular liquid chromatography pump system in a first embodiment.

FIG. 2 is a rear perspective view of a modular liquid chromatography pump system in a first embodiment.

FIG. 3 is a front perspective view of a modular liquid chromatography pump system in a first embodiment in a first configuration.

FIG. 4 is a front perspective view of a modular liquid chromatography pump system in a first embodiment in a second configuration.

FIG. 5 is a front perspective view of a modular liquid chromatography pump sub-system in a first embodiment and/or a standalone second embodiment.

FIG. 6 is a front view of a modular liquid chromatography pump sub-system in a first embodiment and/or a standalone second embodiment.

FIG. 7 is a rear view of a modular liquid chromatography pump sub-system in a first embodiment and/or a standalone second embodiment.

FIG. 8 is a top view of a modular liquid chromatography pump sub-system in a first embodiment and/or a standalone second embodiment.

FIG. 9 is a bottom view of a modular liquid chromatography pump sub-system in a first embodiment and/or a standalone second embodiment.

FIG. 10 is a first side view of a modular liquid chromatography pump sub-system in a first embodiment and/or a standalone second embodiment.

FIG. 11 is a second side view of a modular liquid chromatography pump sub-system in a first embodiment and/or a standalone second embodiment.

FIG. 12 is a first partially transparent perspective view of a modular liquid chromatography pump sub-system in a first embodiment and/or a standalone second embodiment.

FIG. 13 is a second partially transparent perspective view of a modular liquid chromatography pump sub-system in a first embodiment and/or a standalone second embodiment.

### DETAILED DESCRIPTION OF THE ILLUSTRATED EMBODIMENT

The present invention in its various embodiments, some of which are depicted in the figures herein, is a modular liquid chromatography system. In general, the system includes a base member and/or one or more independent pump units configured to removably attach to and generally within the base member.

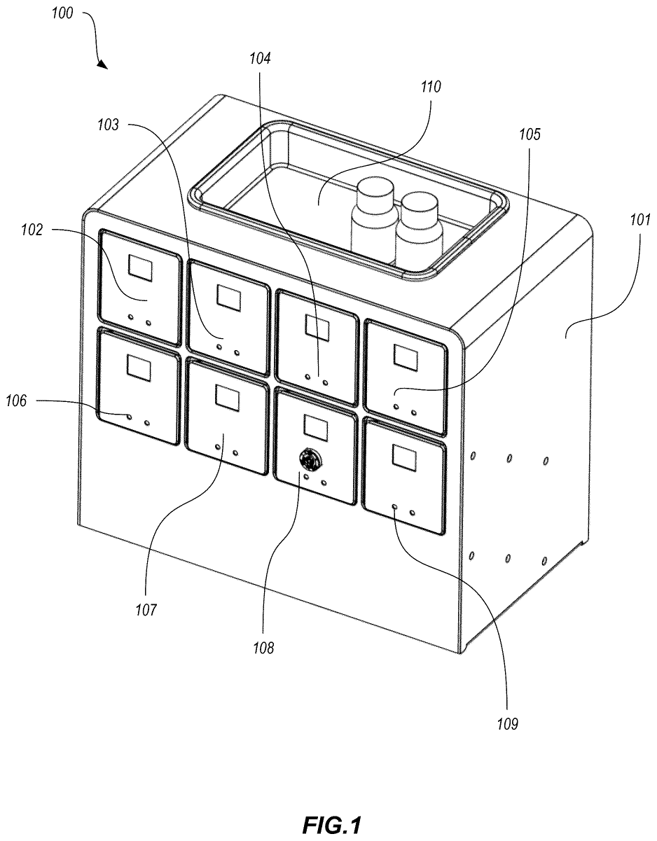

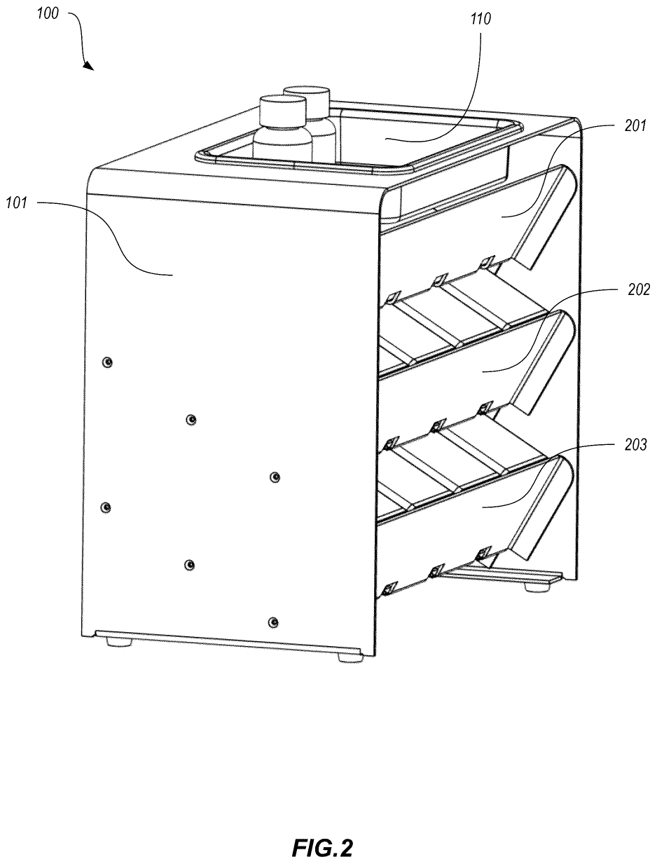

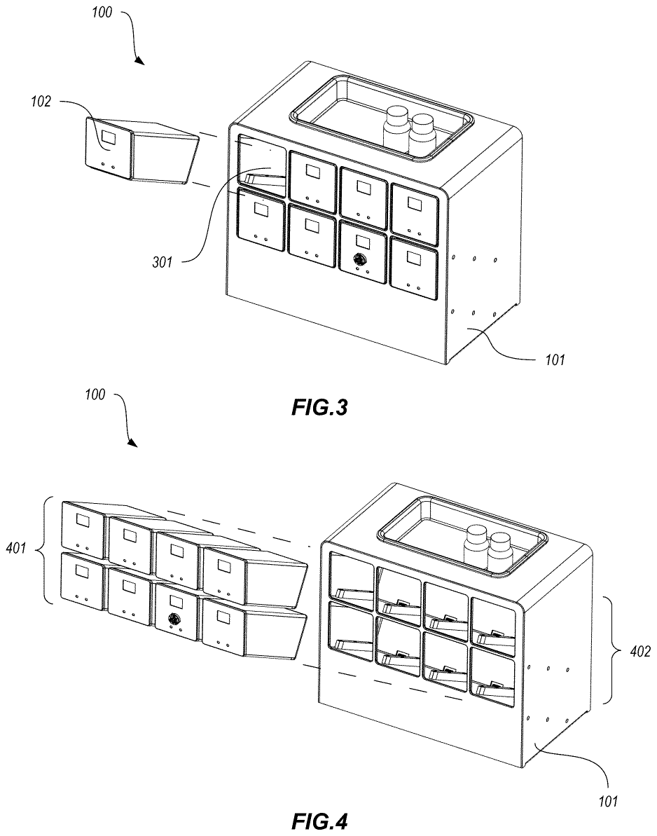

Referring now to FIGS. 1 through 4, one embodiment of the modular liquid chromatography system 100 may include a base member 101 with one or more pump units 102 109. Base member 101 may be formed as a cabinet with one 301, two, or a plurality 402 of recesses with one or more shelves and/or tiers 201, 202, 203 that are configured receive and removably retain pump units 102-109 and/or 401. Pump units and/or recesses of base member may be uniformly sized and dimensioned such that each pump unit in the system can fit in any recess of base member and/or each recess can house any pump unit. Exemplary dimensions are around 22 inches wide, 19 inches high and 12 inches deep for the base member 101 and 4×4×10 inches for the pump unit. However, other sizes and/or dimensions for base member and/or pump unit may be used without departing from the purpose or scope of the invention. In the illustrated embodiment, the shelves and/or tiers 201, 202, 203 of the base member 101 angle downwards from the front of the base member 101 to the back of the base member 101. Base member 101 may include other features such as one or more additional (e.g., top) recesses for equipment and/or mobile phase storage 110.

Significantly, pump units 102-109 and/or 401 are each formed as fully contained and modular components capable of independent pump operation for performing liquid chromatography. Pump units 102-109 and/or 401 may be configured to removably attach to and generally within the recesses 402 of the base member 101. Each pump unit may either be considered as a sub-system within the first embodiment described herein, or as an entirely separate second embodiment of the system.

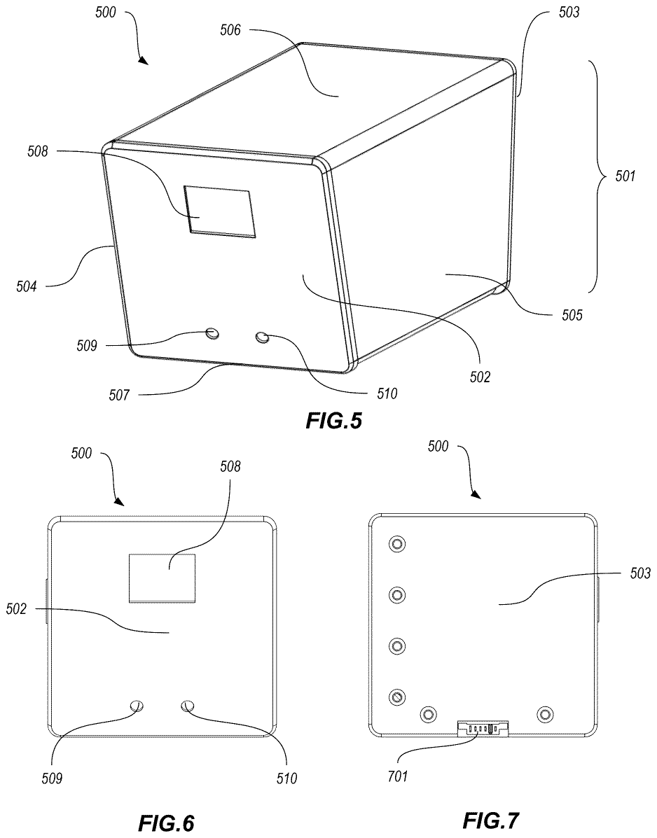

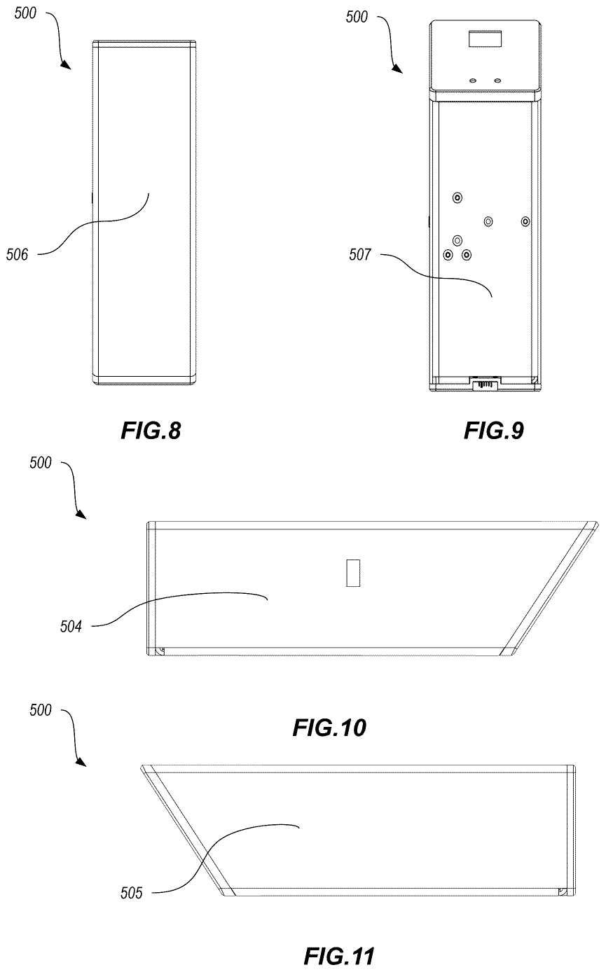

Referring now to FIGS. 5 through 11, pump unit 500 is substantially encased in a housing 501 that is configured to removably attach to and generally within a recess of the base member 101. In the illustrated embodiment, pump unit 500 is elongate and/or rectangular with a front side 502, back side 503, left side 504, right side 505, top side 506, and bottom side 507. Front side 502 may have an LCD, LED, or other display 508 to show various modes of operation, measurements, etc. related to the operation of the pump unit 500. Front side 502 may also have a first aperture 509 configured as an inlet and a second aperture 510 configured as an outlet for performing liquid chromatography. Back side 503 may have a connector 701 for power and/or communication between the pump unit 500 and an external controller and/or computer. Connector 701 may also be configured to dock with the base member 101.

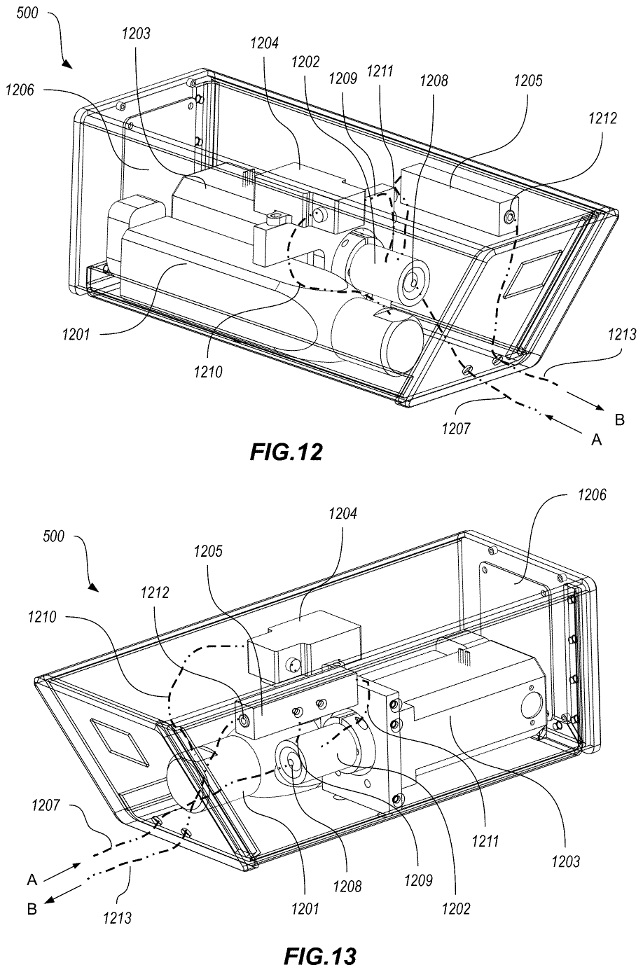

Referring now to FIGS. 12 and 13, the exemplary components of and fluid path relative to the pump unit are shown in one embodiment. Pump unit 500 is generally configured for performing liquid chromatography and may have one or more components for that purpose, including: a pump 1201 (such as, for example, a syringe pump) configured for moving fluid into and out of the pump unit 500; a valve 1202 (such as, for example, a switching valve) connected to an actuator 1203 and configured to regulate the flow of fluid into and out of the pump unit 500; a pressure sensor 1204 configured to measure pressure and, in certain embodiments, be in communication with the pump 1201; a flow sensor 1205 configured to measure flow rate and, in certain embodiments; and a circuit board 1206 (e.g., PCB), onboard electronics, and/or a computer and processor with memory that is connected to one or more of the foregoing components and configured to perform various operations of the pump unit and its components, including according to various modes and/or preset instructions, which may be initiated, changed, or stopped by a user through an external controller and/or computer.

Modes and/or preset instructions may include, one, some, and/or all of the following: a fill mode whereby the valve is open and the pump is fillable and/or filled with fluid; a block mode whereby the valve is closed and fluid does not move through the pump unit; and a flow mode whereby the valve is open and fluid may move through the pump unit.

An exemplary fluid path is shown in the illustrated embodiment, as well as a series of the components described above to control fluid along such path. In FIGS. 12 and 13, fluid path is represented by a dash-dot line segments that stand in for hose and/or line. Fluid may enter the pump unit 500 from direction A, through the inlet aperture 509 to an inlet 1208 on the valve 1202 (segment 1207). Fluid passes cyclically back and forth through segments 1209 and 1210 through the pressure sensor 1204 between the pump 1201 and the valve 1202. Fluid passes from the valve 1202 to the flow sensor 1205 through segment 1211. Finally, fluid passes from the outlet 1212 of the flow sensor 1205, and through the pump unit outlet aperture in direction B (segment 1213). Fluid flow and/or components in the series may differ depending on the specific embodiment employed without departing from the purpose or scope of the invention. generally square and/or rectangular liner member 100 with a top 101 and bottom (not shown), as

So configured, the modular liquid chromatography system presents a number of advantages over the prior art. First, each pump unit can independently execute diagnostic workflows. This allows for specific issues such as blockages, leaks, or inaccuracies in flow rate to be identified and addressed individually without affecting the entire system (as otherwise occurs in more integrated systems). Second, the system supports the development of more complex diagnostic routines that assess overall system performance. For instance, within a fixed volume of pumping, pressure increases and accumulated flow rates can be compared against standard values to identify discrepancies, aiding in early detection of potential problems. Third, should an issue be detected within a particular pump unit, it can be easily and quickly exchanged for another functional pump unit. This modular approach simplifies maintenance and reduces the likelihood of operational downtime due to prolonged repairs.

Continuing with the advantages of the configuration: Fourth, the combination of independent diagnostics and facile exchange capabilities means that many pump-related issues can be identified and resolved remotely. This significantly reduces the need for on-site service technician visits, thereby reducing downtime and associated service costs. Fifth, the discrete pump units can be combined in various configurations to support different chromatographic methods, such as isocratic, binary, ternary, quaternary, and storage loop-based elution systems. For example, a single pump unit in a base unit may be configured for isocratic separation, two pump units in the base unit for binary gradient separation, four pump units in the base unit for quaternary gradient separation, five pump units in the base unit incorporating binary pumping and two storage loops for complex separations—all in a single modular system. This versatility allows the system to adapt to a range of workflows. Sixth, instrument configuration changes can be effortlessly performed at either the manufacturing site or by the user thanks to a plug-and-play design. This flexibility facilitates easy system upgrades or reconfigurations based on changing needs or advancements in technology.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A modular liquid chromatography pump system comprising:
a base member;
a pump unit configured to removably attach to and generally within the base member and having a pump configured for moving fluid into and out of the pump unit.

2. The modular liquid chromatography pump system of claim 1 further comprising two or more pump units, each pump unit configured to removably attach to and generally within the base member and having a pump configured for moving fluid into and out of the pump unit.

3. The modular liquid chromatography pump system of claim 2, wherein one of the two or more pump units is operable to pump fluid within the base member regardless of whether the other of the two or more pump units is operable to pump fluid within the base member.

4. The modular liquid chromatography pump system of claim 1 further comprising a plurality of pump units each configured to removably attach to and generally within the base member and configured for moving fluid into and out of the pump unit.

5. The modular liquid chromatography pump system of claim 1, the pump unit further comprising a valve in communication with the pump and configured to regulate the flow of fluid into and out of the pump unit.

6. The modular liquid chromatography pump system of claim 5, the pump unit further comprising a pressure sensor in communication with one or more of the pump and valve.

7. The modular liquid chromatography pump system of claim 5, the pump unit further comprising a flow sensor in communication with one or more of the pump and the valve.

8. The modular liquid chromatography pump system of claim 5, the pump unit further configured to operate in one or more of the following modes:
a fill mode whereby the valve is open and the pump is one of fillable and filled with fluid;
a block mode whereby the valve is closed and fluid does not move through the pump unit; and
a flow mode whereby the valve is open and fluid may move through the pump unit.

9. A modular liquid chromatography pump system comprising:
a base member with two or more recesses;
two or more pump units configured for performing liquid chromatography, each pump unit having
a pump configured for moving fluid into and out of the pump unit, and
a valve configured to regulate the flow of fluid into and out of the pump;
wherein each pump unit is substantially encased in its own housing that is configured to removably attach to and generally within a recess of the two or more recesses.

10. The modular liquid chromatography pump system of claim 9, wherein the pump and valve of each pump unit are configured to be in communication in a series within the pump unit.

11. The modular liquid chromatography pump system of claim 9, each pump unit further comprising a pressure sensor configured to be in communication with the pump and located between the valve and the pump in the series within the pump unit.

12. The modular liquid chromatography pump system of claim 9, each pump unit further comprising a flow sensor configured to be in communication with the valve and after the valve in the series within the pump unit.

13. The modular liquid chromatography pump system of claim 9, each pump unit further configured to operate in one or more of the following modes:
a fill mode whereby the valve is open and the pump is one of fillable and filled with fluid;
a block mode whereby the valve is closed and fluid does not move through the pump unit; and
a flow mode whereby the valve is open and fluid may move through the pump unit.

14. A modular liquid chromatography pump system comprising:
a pump unit configured for performing liquid chromatography and having
a pump configured for moving fluid into and out of the pump unit; and
a valve configured to regulate the flow of fluid into and out of the pump unit;
wherein the pump unit is substantially encased in a housing that is configured to removably attach to and generally within a base member.

15. The modular liquid chromatography pump system of claim 14, wherein the base member is a cabinet.

16. The modular liquid chromatography pump system of claim 14, wherein the pump and valve are configured to be in communication in a series.

17. The modular liquid chromatography pump system of claim 16, the pump unit further comprising a pressure sensor configured to be in communication with the pump and located between the valve and the pump in the series.

18. The modular liquid chromatography pump system of claim 16, the pump unit further comprising a flow sensor configured to be in communication with and after the valve in the series.

19. The modular liquid chromatography pump system of claim 14, the pump unit further configured to operate in one or more of the following modes:
a fill mode whereby the valve is open and the pump is one of fillable and filled with fluid;
a block mode whereby the valve is closed and fluid does not move through the pump unit; and
a flow mode whereby the valve is open and fluid may move through the pump unit.
